(19) United States
(12) Patent Application Publication
(10) Pub. No.: US 2005/0197436 A1
(43) Pub. Date: Sep. 8, 2005

(54) Flame resistant thermal interface material

(75) Inventor: Pawel Czubarow, Wellesley, MA (US)

Correspondence Address: TOLER & LARSON & ABEL L.L.P., 5000 PLAZA ON THE LAKE STE 265, AUSTIN, TX, 78746, US

(73) Assignee: Saint-Gobain Performance Plastics Corporation

(21) Appl. No.: 10/795,136

(22) Filed: Mar. 5, 2004

(51) Int. Cl. C08K 3/08; C08K 3/38; C08K 3/18

(52) U.S. Cl. 524/405; 524/430

(57) ABSTRACT

A flame resistant material is disclosed, which includes a polymer composite. The polymer composite includes iron oxide in an amount at least about 0.1 wt. % and not greater than about 5.0 wt. % of the polymer composite, hydrated metal oxide in an amount at least about 0.1 wt. % and not greater than about 5.0 wt. % of the polymer composite, zinc borate in an amount at least about 0.1 wt. % and not greater than about 5.0 wt. % of the polymer composite, and polymer.

### TECHNICAL FIELD OF THE DISCLOSURE

The present invention is generally directed to thermally conductive flame resistant s, and in particular to thermal interface components that exhibit flame resistant behavior.

### BACKGROUND

Electronic components, such as printed circuit boards, power supplies, microprocessors, and power subassemblies for such microprocessors, generate considerable heat. Market pressures push for smaller, faster and more sophisticated end products, which occupy less volume and operate at high current densities. Higher current densities further increase heat generation and, often, operating temperatures. If heat is not adequately removed, increased temperatures result in degraded performance and possibly damage to semiconductor components.

Heat sinks are commonly used to transfer heat away from heat generating components and reduce operating temperatures. Exemplary heat sinks include frames, chassis heat spreaders, and plates or bodies formed of conductive metal. In addition, heat sinks may include fins or shaped protrusions to increase surface area and heat dissipation. Typical heat sinks are generally formed of metal, and, as such, electrical isolation from heat producing components is desired.

To electrically isolate yet provide thermal contact, a thermal interface component is typically placed between the heat generating electronic components and the heat sink. Thermally conductive interface materials function to electrically isolate the electrical components from the heat sink, while conducting heat from the electrical components to the heat sink.

As performance characteristics and, as a consequence, power densities and operating temperatures increase, the industry has gained interest in improving flame resistance and fire retardation in thermal interface materials. However, materials generally used in these applications, such as waxes, thermal greases, and polymeric materials, exhibit poor performance either as a thermally conductive material and/or in flame resistance. As such, improved thermal interface materials, components incorporating same, and methods of forming same are generally desirable.

### SUMMARY OF THE INVENTION

According to one embodiment, a flame resistant material includes a polymer composite. The polymer composite includes iron oxide in an amount at least about 0.1 wt. % and not greater than about 5.0 wt. % of the polymer composite, hydrated metal oxide in an amount at least about 0.1 wt. % and not greater than about 5.0 wt. % of the polymer. composite, zinc borate in an amount at least about 0.1 wt. % and not greater than about 5.0 wt. % of the polymer composite, and polymer.

According to another embodiment, a thermal interface component includes a layer comprising a polymer composite comprising silicone polymer, iron oxide in an amount at least about 0.1 wt. % and not greater than about 5.0 wt. % of the polymer composite, alumina trihydrate in an amount at least about 0.1 wt. % and not greater than about 5.0 wt. % of the polymer composite, and zinc borate in an amount at least about 0.1 wt. % and not greater than about 5.0 wt. % of the polymer composite.

According to a further embodiment, a flame resistant material includes a polymer composite comprising a polymer and not more than about 20 wt. % flame retardant. The flame retardant comprises iron oxide, hydrated metal oxide in an amount at least about 0.1 wt. % and not greater than about 5.0 wt. % of the polymer composite, and vitrifying agent.

According to an additional embodiment, a thermally conductive polymeric material has a cumulative flame time not greater than 50 seconds, a glow time not greater than about 30 seconds, and a thermal conductivity at least about 0.5 W/m·K.

According to another embodiment, a flame retardant material comprises platinum catalyzed silicone and hydrated metal oxide in an amount at least about 0.1 wt. % and not greater than about 5.0 wt. % and has vertical burn test characteristics of at least V-1 according to UL94.

According to a further embodiment, a flame resistant material includes a polymer composite. The polymer composite includes iron oxide in an amount at least about 0.1 wt. % and not greater than about 5.0 wt. % of the polymer composite, hydrated agent in an amount at least about 0.1 wt. % and not greater than about 5.0 wt. % of the polymer composite, vitrifying agent in an amount at least about 0.1 wt. % and not greater than about 5.0 wt. % of the polymer composite, and polymer.

### BRIEF DESCRIPTION OF THE DRAWINGS

The present invention may be better understood, and its numerous objects, features, and advantages made apparent to those skilled in the art by referencing the accompanying drawings.

FIG. 1 depicts an exemplary embodiment of a thermal interface component.

FIG. 2 depicts an exemplary application of the thermal interface component.

The use of the same reference symbols in different drawings indicates similar or identical items.

### DETAILED DESCRIPTION

According to an aspect of the present invention, a thermal interface component is provided including one or more layers. At least one of these layers includes a polymer composite having a blend of flame retardants. The blend of flame retardants may include, for example, iron oxide, alumina trihydrate and zinc borate. In addition, the polymer composite may optionally include thermally conductive filler, such as anhydrous alumina or boron nitride. In one particular embodiment, the polymer composite includes silicone, silicone elastomer, silicone gel. Silicone gels may be particularly desirable for its tack properties.

According to a further aspect of the invention, a flame resistant material is provided that generally includes a polymer composite including a blend of flame retardants. The blend of flame retardants includes iron oxide, a hydrated agent, such as hydrated alumina, preferably alumina trihydrate, and a vitrifying component, such as metal borates, preferably zinc borate. When subjected to bum testing, such as according to Underwriter Laboratories UL94 standards, the flame resistant material may exhibit behaviors consistent with or better than UL94 V-2, such as V- 1, or desirably V-0. The polymer composite may further include thermally conductive fillers, such as alumina and boron nitride. As a result, the flame resistant material may have a thermal conductivity not less than about 0.5 W/m·K, such as not less than 1.0 W/m·K or not less than 2.0 W/m·K.

The polymer composite of the flame resistant material may be formed of polymers and elastomeric materials, such as polyolefins, polyesters, fluoropolymers, polyamides, polyimides, polycarbonates, polymers containing styrene, epoxy resins, polyurethane, polyphenol, silicone, or combinations thereof. In one exemplary embodiment, the polymer composite is formed of silicone, silicone elastomer, and silicone gels. Silicone, silicone elastomer, and silicone gels may be formed using various organosiloxane monomers having functional groups such as alkyl groups, phenyl groups, vinyl groups, glycidoxy groups, and methacryloxy groups and catalyzed using platinum-based or peroxide catalyst. Exemplary silicones may include vinylpolydimethylsiloxane, polyethyltriepoxysilane, dimethyl hydrogen siloxane, or combinations thereof. Further examples include aliphatic, aromatic, ester, ether, and epoxy substituted siloxanes. In one particular embodiment, the polymer composite comprises vinylpolydimethylsiloxane. In another particular embodiment, the polymer composite comprises dimethyl hydrogen siloxane. Silicone gels are of particular interest for tackiness and may be formed with addition of a diluent.

The polymer composite may comprise at least about 10 wt. % and not greater than about 90 wt. % polymer. For example, the polymer composite may include polymer in an amount at least about 10 wt. % and not greater than 40 wt. %. In one particular embodiment, the polymer of the polymer composite is silicone, silicone elastomer, and silicone gel.

Turning to the blend of flame retardants, flame retardants may include organic and inorganic components. Organic flame retardants include organic aromatic halogenated compounds, organic cycloaliphatic halogenated compounds, and organic aliphatic halogenated compounds. Exemplary organic compounds may include brominated or chlorinated organic molecules. Exemplary embodiments include but are not limited to hexahalodiphenyl ethers, octahalodiphenyl ethers, decahalodiphenyl ethers, decahalobiphenyl ethanes, 1,2-bis(trihalophenoxy)ethanes, 1,2-bis(pentahalophenoxy)ethanes, hexahalocyclododecane, a tetrahalobisphenol-A, ethylene(N,N′)-bis-tetrahalophthalimides, tetrahalophthalic anhydrides, hexahalobenzenes, halogenated indanes, halogenated phosphate esters, halogenated paraffins, halogenated polystyrenes, and polymers of halogenated bisphenol-A and epichlorohydrin, or mixtures thereof.

Inorganic flame retardants may include metal compounds containing oxygen such as hydroxides, oxides, carbonates, silicates, molybdates, or other compounds such as mineral compounds. Typical examples may include antimony trioxide, antimony pentoxide, sodium antimonite, hydrated aluminum oxide, zinc oxide, iron oxide, titanium dioxide, aluminum hydroxide, magnesium hydroxide, kaolin, molybdenum trioxide, aluminum silicates, antimony silicates, zinc stannate, magnesium hydroxide, zirconium hydroxide, basic magnesium carbonate, dolomite, hydrotalcite, calcium hydroxide, barium hydroxide, bismuth oxide, tungsten trioxide, a hydrate of tin oxide, a hydrate of an inorganic metallic compound such as borax, zinc borate, zinc metaborate, barium metaborate, zinc carbonate, magnesium carbonate-calcium, calcium carbonate, barium carbonate, magnesium oxide, molybdenum oxide, zirconium oxide, tin oxide, red phosphorous, and ceramic materials. The flame retardants may be used alone or in a combination of two or more thereof. Grain size of the flame retardant varies with the particular species, but with regard to magnesium hydroxide, aluminum hydroxide and the like, the average grain size is preferably 20 μm or less, more preferably within the range of 0.3 to 5.0 μm.

In one exemplary embodiment, the flame retardants may be included in the polymer composite in a blend including at least three components. In one particular embodiment, the blend may include a metal oxide, a hydrated agent, such as a hydrated metal oxide, and a glass forming compound or vitrifying agent, such as a metal borate or metal silicate. For example, the flame retardant blend may include iron oxide, hydrated alumina, such as alumina trihydrate (ATH), and zinc borate. The flame retardant blend may be included in the polymer composite in amounts not to exceed 20 wt. %, such as not greater than about 15 wt. %. In one particular embodiment, the blend of flame retardants includes iron oxide, such as Fe₂O₃ in an amount at least about 0.1 wt. % and not greater than 5.0 wt. % of the polymer composite, alumina trihydrate in an amount at least about 0.1 wt. % and not greater than 5.0 wt. % of the polymer composite, and zinc borate in an amount at least about 0.1 wt. % and not greater than 5.0 wt. % of the polymer composite. In one example, the polymer composite includes iron oxide in an amount between 1.0 wt. % and 4.0 wt. %. In another exemplary embodiment, the polymer composite includes ATH in an amount between about 1.0 wt. % and 4.0 wt. %. In a further exemplary embodiment, the polymer composite includes zinc borate in an amount between about 1.0 wt. % and about 4.0 wt. %.

According to embodiments of the present invention, it is believed that several mechanisms for flame retardation work together to provide high levels of performance. One possible mechanism for flame retardation is the release of water by hydrated agents such as hydrated metal oxides, such as hydrated alumina, hydrated tin oxide, and hydrated magnesium oxide. The release of water and the transition of the water through various phases absorb energy, reducing heat and energy available for propagating a flame. Another possible mechanism for flame retardation is the formation of crusty glasses or thermally resistant char in the region of the flame with vitrifying agents. Metal borates, such as zinc borate, and metal silicates, such as aluminum silicate, may act as vitrifying agents. The crusty glass or char may prevent heat and oxygen from contacting unreacted polymer composite, preventing ignition or self-sustained burning.

Embodiments of the flame resistant material exhibit flame resistant characteristics in accordance with the Underwriters Laboratory 94 (UL94) standard. For example, using the ASTM D635 vertical burn test the flame resistant material may exhibit flame times after the first or second application of heat not greater than about 30 seconds, such as not greater than about 10 seconds. In addition, the flame resistant material may exhibit a total flame time after the application of both the first and the second application of heat added over 5 samples (herein termed “cumulative flame time”) of not greater than 250 seconds, such as not greater than 50 seconds. Furthermore, the flame resistant material may exhibit a glow time after the second application of heat not greater than 60 seconds, such as not greater than 30 seconds. The burn test may also fail to burn to the holding clamp and fail to ignite cotton. As such, the flame retardant material may be characterized as a better than a UL94 V-2 compliant material, such as being characterized as a UL94 V-I material, or a UL94 V-0 material.

The polymer composite may further include fillers. Examples of fillers include talc, calcium carbonate, glass fibers, marble dust, cement dust, clay feldspar, silica or glass, fumed silica, alumina, magnesium oxide, magnesium hydroxide, antimony oxide, zinc oxide, barium sulfate, aluminum silicate, calcium silicate, titanium dioxide, titanates, glass microspheres or chalk. These fillers may be employed in amounts from 1 to 90, preferably from 1 to 80, more preferably from 1 to 70 wt. % of the polymer composite.

In one particular embodiment, the polymer composite includes fillers that exhibit high thermal conductivity while having relatively high electrical resistivity. For example, the filler may have a thermal conductivity at least about 10 W/m·K and an electrical resistivity at least about 10₁₀ Ohm-cm. Exemplary thermally conductive fillers include anhydrous or calcined alumina, boron nitride, aluminum nitride, beryllium oxide, silicon carbide, and combinations thereof. Table 1 depicts the thermal conductivity properties of exemplary thermally conductive filler. The thermally conductive filler may be provided in amounts at least about 20 wt. % and not more than about 90 wt. % of the polymer composite. For example, the polymer composite may include at least about 50 wt. % and not greater than about 85 wt. % thermally conductive filler or at least about 75 wt. % and not greater than 85 wt. % thermally conductive filler. In one particular embodiment, the fire resistant material may exhibit a thermal conductivity of at least about 0.5 W/m·K, such as at least about 1.0 W/m·K or at least about 2.0 W/m·K.

TABLE 1

| Thermally Conductive | Thermal Conductivity |
|---|---|
| Filler | (W/m · K) |
| Alumina | 40 |
| Aluminum Nitride | 170-200 |
| Beryllium Oxide | 280 |
| Silicon Carbide | 200-300 |
| Boron Nitride | 125 |

It is noted that different forms of aluminous materials are described herein including flame retardants and thermally conductive filler. Aluminum oxides are found in hydrated and anhydrous forms. Hydrated aluminum oxides or hydrated alumina may be found in trihydroxides such as alumina trihydrate, gibbsite, bayerite, and nordstrandite, as well as other hydrated forms, such as alumina monohydrate, boehmite and diaspore. The degree of hydration of alumina may be expressed in indices n found in the formula Al₂O₃.nH₂O, wherein n may, for example, be a number between 0.5 and 6, such as 0.5, 1, 2, and 3. Hydrated aluminas, such as typically used gibbsite, may be calcined or thermally treated (including sintering) to drive off or remove adsorbed or absorbed water. Anhydrous (e.g. calcined or dehydrated) alumina (or just “alumina”) is generally incorporated to function as electrically resistive thermally conductive filler. On the other hand, hydrated alumina, such as alumina trihydrate (ATH) or aluminum hydroxide functions as a flame retardant.

In one particular embodiment, a blend of flame retardants was added to a platinum catalyzed silicone. The blend included iron oxide, alumina trihydrate and zinc borate. In particular examples, alumina trihydrate loading in excess of 10.0 wt. % poisoned the platinum catalyst and amounts in excess of 5.0 wt. % reduced the effectiveness of the platinum catalyst. As such, embodiments typically include less than 10 wt. %, and desirably less than about 5 wt. %. Examples having not greater than 20 wt. % of a flame retardant blend and not greater than 5.0 wt. % alumina trihydrate proved especially effective at achieving UL94 V-0 characteristics.

In another exemplary embodiment, samples of the silicone composite having amounts greater than 10 to 15 wt. % iron oxide caused staining or dyeing of adjacent articles, layers, and components. As such, a flame retardant blend providing no more than 15 wt. %, more typically 10 wt. %, such as 5.0 wt. % iron oxide in the polymer composite proved desirable.

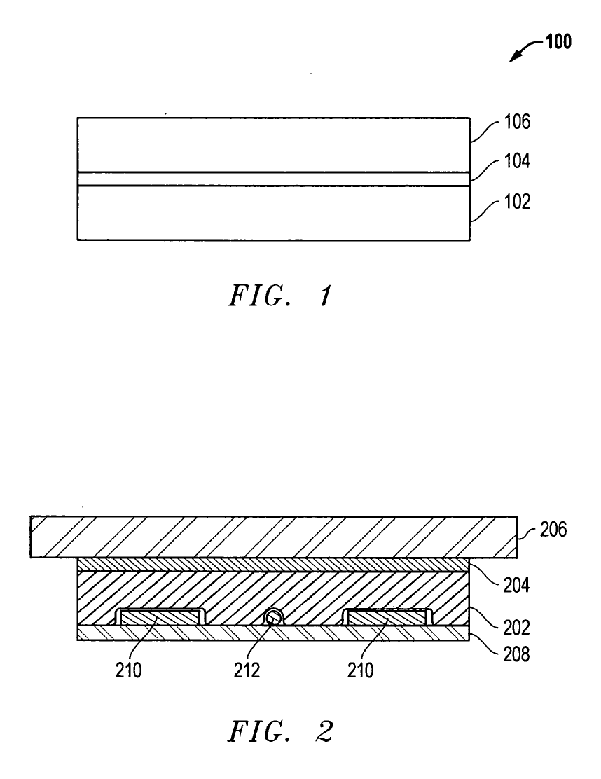

Turning to FIG. 1, thermal interface component 100 includes an electrically isolating and thermally conducting layer 102, a reinforcing layer 104, and a second thermally conducting layer 106. The reinforcing layer 104 provides for structural integrity and support of layer 102. Reinforcing layer 104 is desirably thermally conductive, having thermal conductivity properties at least as good as if not better than that of layer 102. Similarly, layer 106 may be at least as electrically isolating and thermally conductive as layer 102.

Layer 102 may include a polymer composite having a blend of flame retardants as described above in detail. For example, a blend of flame retardants may include iron (III) oxide, alumina trihydrate and zinc borate. The polymer composite may, for example, include no more than about 20% by weight of the blend of flame retardants. In addition, the blend of flame retardants may include alumina trihydrate in an amount of at least about 0.1 wt. % to 5.0 wt. %, such as an amount of at least about 1.0 wt. % and not greater than about 4.0 wt. % of the composite. The blend may also include iron oxide in an amount of at least about 0.1 wt. % and not greater than 5.0 wt. %, such as an amount of at least about 1.0 wt. % and not greater than about 4.0 wt. % of the composite. Further, the blend of flame retardant may include zinc borate in an amount of at least about 0wt. % and not greater than 5.0 wt. %, such as an amount of at least about 1.0 wt. % and not greater than about 4.0 wt. % of the composite. The polymer composite may further include thermally conductive fillers such as alumina and boron nitride, comprising between about 20 wt. % and 90 wt. % of the polymer composite.

In a particular embodiment, the polymer composite comprises a silicone elastomer or silicone gel having iron oxide, such as Fe₂O₃, hydrated alumina, such as alumina trihydrate, and zinc borate, each in an amount at least about 0.1 wt. % and not greater than 5.0 wt. % of the polymer composite. The silicone composite may further include about 75-85 wt. % alumina.

Layer 104 may include reinforcement components such as fiberglass, and metal foils and meshes. Use of reinforcement is generally desirable to enhance structural integrity. However, in some exemplary embodiments, the polymer layers may be self-supporting.

Layer 106 may include a polymer composite having a flame retardant and thermally conductive composition. In one particular embodiment, layer 106 includes a polymer composition similar to layer 102.

In alternate embodiments, the thermal interface component may be a single layer such as layer 102. In certain applications, layer 102 may be a self-supporting application and reinforcement may not be used. In other embodiments, the thermal interface component may include layers 102 and 104 such that layer 104 contacts the heat sink. In further embodiments, additional layers may be included, such as between layer 102 and 104, between layers 104 and 106, and about layers 102 and 106. These additional layers may have similar compositions to those described in relation to layer 102 or compositions that further enhance thermal conductivity and thermal contact with heat sinks. In further embodiments, carrier films and release films, such as polyolefin films, may be applied to at least one of or both layers 102 and 104 to enhance product transport and application. The carrier films may form a bandoleer from which the thermal interface component is removed during application to the electrical component.

Turning to FIG. 2, the thermal interface component is depicted in an application where heat generated in electronic components 210 and 212 and circuit board 208 are transferred through layers 202 and 204 of the thermal interface material to a heat sink 206. Layer 202 may for example be an elastomeric or gel silicone polymer composite including iron oxide, alumina trihydrate, and zinc borate, each in amount at least about 0.1 wt. % and not greater than 5.0 wt. % of the composite. The elastomeric silicone polymer composite may further include between. about 20 wt. % and 90 wt. % thermally conductive filler, such as anhydrous alumina and boron nitride.

Layer 204 may, for example, be a metallic film such as an aluminum foil or a reinforcement layer such as fiberglass or polyester fibers. Heat is generally transferred from the printed circuit board 208 and electronic components 210 and 212 through layers 202 and 204 to the heat sink 206. The heat sink may, for example, be a frame or chassis associated with the electronic component or a finned metallic heat sink.

In an alternate embodiment, layer 202 may be self-supported and not include a reinforcement layer. In a further embodiment, an additional layer may be included above layer 204. The additional layer may be a second thermally conductive polymeric layer.

### EXAMPLE 1

Sample test strips were formed using a platinum catalyzed silicone. The composition included GE RTV silicone, calcined alumina filler, Fe₂O₃ Zmag 5213, zinc borate Firebrake ZB and ATH Space Rite S-3, in the compositions listed in Table 2.

TABLE 2
Composition

| Component | Weight % |
|---|---|
| Calcined alumina filler | 80.00 |
| Fe₂O₃ Zmag 5213 | 2.00 |
| Zinc Borate Firebrake ZB | 2.00 |
| ATH Space Rite S-3 | 2.00 |
| GE RTV Silicone | 14.00 |

Five test strips having dimensions 125+/−5 mm by 13 +/−0.05 mm with sample thickness of 13 mm maximum were subjected to a vertical burn test ASTM D635. As shown in Table 3, in each of these samples, the first application of heat resulted in a 0 second burn time and the second application of heat resulted in a maximum 6 second burn time. For each of these samples, the glow time after the second application of heat typically lasted between 10 and 12 seconds. In each of the samples, the samples failed to burn to the clamp or ignite cotton. The longest burn time was 6 seconds and the sum of all burn times or “cumulative burn time” was 6 seconds. The single longest second burn time plus glow time was less than or equal to 16 seconds. As such, each of the samples achieved a UL94 V-0 rating.

TABLE 3
Test results:

| | | | Glow | Burn to | Ignite |
|---|---|---|---|---|---|
| Sample | 1^{st} Burn | 2^{nd} Burn | Time | Clamp? | Cotton? |
| No. | (s) | (s) | (s) | (y or n) | (y or n) |
| 1 | 0 | 0 | 10 | n | n |
| 2 | 0 | 0 | 12 | n | n |
| 3 | 0 | 0 | 10 | n | n |
| 4 | 0 | 0 | 10 | n | n |
| 5 | 0 | 6 | 10 | n | n |

### EXAMPLE 2

Sample test strips were formed using a platinum catalyzed silicone. The composition included GE RTV silicone, Silbond 40, calcined alumina filler, Fe₂O₃ Zmag 5213, zinc borate Firebrake ZB and ATH Space Rite S-3, in the compositions listed in Table 4.

TABLE 4
Composition

| Component | Weight % |
|---|---|
| Calcined alumina filler | 78.00 |
| Fe₂O₃ Zmag 5213 | 2.00 |
| Zinc Borate Firebrake ZB | 2.00 |
| ATH Space Rite S-3 | 2.00 |
| GE RTV Silicone | 15.50 |
| Silbond 40 | 0.50 |

Five test strips having dimensions 125+−5 mm by 13+/−0.05 mm with sample thickness of 13 mm maximum were subjected to a vertical burn test ASTM D635. As shown in Table 5, in each of these samples, the first application of heat resulted in a 0 second burn time and the second application of heat resulted in a maximum 8 second burn time. For each of these samples, the glow time after the second application of heat typically lasted between 2 and 5 seconds. In each of the samples, the samples failed to burn to the clamp or ignite cotton. The longest burn time was 8 seconds and the sum of all burn times or “cumulative burn time” was 27 seconds. The single longest second burn time plus glow time was less than or equal to 13 seconds. As such, each of the samples achieved a UL94 V-0 rating.

TABLE 5
Test results:

| | | | Glow | Burn to | Ignite |
|---|---|---|---|---|---|
| Sample | 1^{st} Burn | 2^{nd} Burn | Time | Clamp? | Cotton? |
| No. | (s) | (s) | (s) | (y or n) | (y or n) |
| 1 | 0 | 4 | 2 | n | n |
| 2 | 0 | 7 | 4 | n | n |
| 3 | 0 | 5 | 4 | n | n |
| 4 | 0 | 8 | 5 | n | n |
| 5 | 0 | 3 | 4 | n | n |

The above-disclosed subject matter is to be considered illustrative, and not restrictive, and the appended claims are intended to cover all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

1. A flame resistant material comprising:
a polymer composite including:
iron oxide in an amount at least about 0.1 wt. % and not greater than about 5.0 wt. % of the polymer composite;
hydrated metal oxide in an amount at least about 0.1 wt. % and not greater than about 5.0 wt. % of the polymer composite;
zinc borate in an amount at least about 0.1 wt. % and not greater than about 5.0 wt. % of the polymer composite; and
a polymer.

2. The flame resistant material of claim 1, wherein iron oxide comprises Fe₂O₃.

3. The flame resistant material of claim 1, wherein the hydrated metal oxide is hydrated alumina.

4. The flame resistant material of claim 3, wherein the hydrated alumina comprises alumina trihydrate.

5. The flame resistant material of claim 1, wherein the polymer is silicone.

6. The flame resistant material of claim 5, wherein the polymer composite comprises at least about 10 wt. % and not greater than about 90 wt. % silicone.

7. The flame resistant material of claim 5, wherein the polymer composite comprises at least about 10 wt. % and not greater than about 40 wt. % silicone.

8. The flame resistant material of claim 1, wherein the polymer composite further comprises a thermally conductive filler.

9. The flame resistant material of claim 8, wherein the thermally conductive filler comprises alumina.

10. The flame resistant material of claim 8, wherein the thermally conductive filler comprises boron nitride.

11. The flame resistant material of claim 8, wherein the polymer composite comprises at least about 20 wt. % and not more than about 90 wt. % thermally conductive filler.

12. The flame resistant material of claim 1, wherein the flame resistant material has a thermal conductivity of at least about 0.5 W/m·K.

13. The flame resistant material of claim 1, wherein the flame resistant material has a thermal conductivity of at least about 1.0 W/m·K.

14. The flame resistant material of claim 1, wherein the flame resistant material has a thermal conductivity of at least about 2.0 W/m·K.

15. The flame resistant material of claim 1, wherein the flame resistant material has a cumulative flame time not greater than 250 seconds and a glow time not greater than 60 seconds.

16. The flame resistant material of claim 1, wherein the flame resistant material has a cumulative flame time not greater than 50 seconds and glow time not greater than 30 seconds.

17. The flame resistant material of claim 1, wherein the amount of hydrated metal oxide is at least about 1.0 wt. % and not greater than about 4.0 wt. % of the polymer composite.

18. The flame resistant material of claim 1, wherein the amount of iron oxide is at least about 1.0 wt. % and not greater than about 4.0 wt. % of the polymer composite.

19. The flame resistant material of claim 1, wherein the amount of zinc borate is at least about 1.0 wt. % and not greater than about 4.0 wt. % of the polymer composite.

20. The flame resistant material of claim 1, wherein the flame resistant material forms a layer.

21. The flame resistant material of claim 20, wherein the layer is included in a thermal interface component.

22. A thermal interface component comprising:
a thermally conductive polymeric layer comprising a polymer composite comprising silicone polymer, iron oxide in an amount at least about 0.1 wt. % and not greater than about 5.0 wt. % of the polymer composite, alumina trihydrate in an amount at least about 0.1 wt. % and not greater than about 5.0 wt. % of the polymer composite, and zinc borate in an amount at least about 0.1 wt. % and not greater than about 5.0 wt. % of the polymer composite.

23. The thermal interface component of claim 22, wherein iron oxide comprises Fe₂O₃.

24. The thermal interface component of claim 22, wherein substantially the entirety of the layer is formed of the polymer composite.

25. The thermal interface component of claim 22, further comprising a reinforcement layer coupled to the thermally conductive polymeric layer.

26. The thermal interface component of claim 25, wherein the reinforcement layer comprises metal foil layer.

27. The thermal interface component of claim 22, further comprising a second thermally conductive polymer layer.

28. A flame resistant material comprising:
a polymer composite comprising a polymer and not more than about 20 wt. % flame retardant, the flame retardant comprising Fe₂O₃, hydrated metal oxide in an amount at least about 0.1 wt. % and not greater than about 5.0 wt. % of the polymer composite, and vitrifying agent.

29. The flame resistant material of claim 28, wherein the hydrated metal oxide comprises hydrated alumina.

30. The flame resistant material of claim 29, wherein the hydrated alumina comprises alumina trihydrate.

31. The flame resistant material of claim 28, wherein the vitrifying agent comprise zinc borate.

32. The flame resistant material of claim 28, wherein the polymer comprises silicone.

33. The flame resistant material of claim 28, wherein the polymer composite further comprises thermally conductive filler.

34. The flame resistant material of claim 33, wherein the thermally conductive filler comprises alumina.

35. The flame resistant material of claim 33, wherein the flame resistant material has a thermal conductivity of at least about 0.5 W/m·K.

36. The flame resistant material of claim 28, wherein the flame resistant material has a cumulative flame time not greater than 250 seconds and glow time not greater than 60 seconds.

37. The flame resistant material of claim 28, wherein the flame resistant material exhibits a vertical burn test rating according to Underwriters Laboratory 94 standard of V-0 and wherein the flame resistant material has a cumulative flame time not greater than 50 seconds and glow time not greater than 30 seconds.

38. A thermally conductive polymeric material comprising a polymer and having a cumulative flame time not greater than 50 seconds, a glow time not greater than about 30 seconds, and having a thermal conductivity at least about 0.5 W/m·K.

39. The thermally conductive polymeric material of claim 38, wherein the polymer comprises silicone.

40. The thermally conductive polymeric material of claim 38, further comprising thermally conductive filler.

41. The thermally conductive polymeric material of claim 39, wherein the thermally conductive filler comprises alumina.

42. A flame retardant material comprising a platinum catalyzed silicone and hydrated metal oxide in an amount at least about 0.1 wt. % and not greater than about 10.0 wt. % and having vertical bum test characteristics at least compliant with V-1 according to UL94.

43. The flame retardant material of claim 42, wherein the material meets V-0 according to UL94, the material having a cumulative flame time not greater than 50 seconds and glow time not greater than 30 seconds.

44. The flame retardant material of claim 42, wherein the hydrated metal oxide comprises hydrated alumina.

45. The flame retardant material of claim 44, wherein the hydrate alumina comprises alumina trihydrate.

46. The flame retardant material of claim 42, wherein material comprises not greater than about 5.0 wt. % hydrated metal oxide.

47. The flame retardant material of claim 42, wherein the material comprises at least about 1.0 wt. % and not greater than about 4.0 wt. % hydrated metal oxide.

48. The flame retardant material of claim 42, having a thermal conductivity of at least about 0.5 W/m·K.

49. A flame resistant material comprising:
a polymer composite including:
Fe₂O₃ in an amount at least about 0.1 wt. % and not greater than about 5.0 wt. % of the polymer composite;
hydrated agent in an amount at least about 0.1 wt. % and not greater than about 5.0 wt. % of the polymer composite;
vitrifying agent in an amount at least about 0.1 wt. % and not greater than about 5.0 wt. % of the polymer composite; and
a polymer.

50. The flame resistant material of claim 49, wherein the vitrifying agent is a metal borate or metal silicate.

51. The flame resistant material of claim 49, wherein the hydrated agent is alumina trihydrate.
